(19) United States
(12) Patent Application Publication
(10) Pub. No.: US 2014/0222988 A1
(43) Pub. Date: Aug. 7, 2014

(54) METHOD FOR ADAPTIVE CONTENT DISCOVERY FOR DISTRIBUTED SHARED CACHING SYSTEM

(71) Applicant: SAMSUNG ELECTRONICS CO., LTD., Gyeonggi-do (KR)

(72) Inventors: Oz SHLOMO, Kfar Saba (IL); Roy FRIEDMAN, Haifa (IL); Dan SHIRRON, Givaat Ada (IL); Yaniv WEIZMAN, Tel-Aviv Jaffa (IL); Itai AHIRAZ, Hod Hashron (IL); Offri GIL, Alfey Menashe (IL)

(73) Assignee: SAMSUNG ELECTRONICS CO., LTD., Gyeonggi-do (KR)

(21) Appl. No.: 13/757,882

(22) Filed: Feb. 4, 2013

(51) Int. Cl. H04L 12/26

(52) U.S. Cl. CPC H04L 43/08
USPC 709/224

(57) ABSTRACT

In a method for the dynamic content discovery in a distributed caching network the distribution of content popularity and its access frequency rate are used to determine the most appropriate mapping method(s) to use.

### FIELD OF THE INVENTION

The present invention relates to the control and management of the highly distributed shared content caching system. More specifically, it relates to the cached item discovery (contained in the control plane system)—the process of determining a cached item location within one or more nodes belonging to the overlay caching network, hereinafter referred to as “the content mapping of a cached item”.

### BACKGROUND OF THE INVENTION

The rapid growth of data services, especially real time and VoD video services forces network operators to deploy content caching solutions within their own networks. Distributed caching architecture system, in which caching servers are highly distributed along network entities, is one of the known solution approaches.

Deploying distributed caching system has significant advantages. First, it caches the content close to network edges, thus reducing the total latency and response time experienced by end users. Secondly, as content is fetched only for the first access (first timer), further accesses for the same content are served locally from the caching entity and thus traffic is offloaded from the (usually congested) core network.

To further improve the performance of a distributed caching system a second level of caching is designed where content is shared among network entities. In that case, an entity missing an accessed content (first content access) will fetch the content from the best available caching entity. The “best available” criterion will depend on the choice of the system manager, but can be, for instance, based on the closest and/or less loaded caching entity. That will further improve response time for first timers and further reduce the load on core network at the cost of additional load between edge entities, which are usually less congested.

Accordingly, a solution for content discovering within the distributed system is required. However, a discovery system may introduce key issues for the network. Firstly, as part of the discovery process, control messages needs to be exchanged between nodes. The messages overhead needs to be minimized, to save network bandwidth for data delivery. Secondly, the discovery process needs to be fast so that the latency it adds to the user experience will be negligible. Thirdly, the efficiency of the discovery process has a significant impact on the data plane content delivery efficiency. A well distributed content mapping knowledge providing information on which nodes are caching a required content, will ensure the selection of the best available candidate to fetch the download from, with a reduction of delivery time and core network traffic offload.

Different types of content have different requirements from a discovery system. A popular real time/live content accessed frequently by different nodes requires frequent and fast distribution of mapping knowledge (even at the cost of added control plane overhead), so that the best caching nodes will be traced in time upon request for content. Failing to do so, will result in a less efficient content delivery from less optimized resources (far nodes or the Internet). On the other hand, popular content accessed less frequently is less sensitive to mapping knowledge distribution and may help to reduce the control overhead within a network.

In light of the above, the discovery system design needs to be dynamic, efficient and well optimized to the operational mode of the system, based on type of content consumed and its related requirements.

The content mapping process includes the dissemination of cached content location repository table of nodes holding it. Two approaches exist in the known art;
Pull (query) based approach—an indirect content mapping approach where intermediate nodes hold a subset of cached items and the nodes holding them are table (DHT based). A node looking for a cached item (local cache miss) queries an intermediate node to obtain the list of nodes holding the cached item.
Push based approach—a direct content mapping approach where each node within the overlay network disseminates its cached items as well as known cached items in other nodes, to other network nodes. In case that a local cache miss happens, a node can obtain the location of the required item using other disseminated location tables.

These two methods are discussed briefly below.

Pull (Query) Based Distributed Mapping Approach

The pull based distributed mapping approach includes a key-value distributed system where each of the nodes in the overlay is responsible for a subset mapping (distributed hash based) between sections and peers that hold copies of them. Still, in order to obtain the list of nodes currently caching the requested content, a node needs to pull/query the responsible mapping node(s).

The DHT (distributed) mapping approach suggests a distributed mapping function where each of the nodes is responsible for mapping subset of cached items mapping tables based on DHT. The DHT need not store any information persistently and there is no need for replication, as detailed in the protocol below.

DHT approaches provide a structured method for key store and lookup services. They also provide solutions for peer join and leave events. The solution specifies an algorithm for routing query or update request to the group of nodes that are responsible for the keys. Such methods are applied in big-data No-SQL databases such as Amazon's DynamoDB and Apache's Cassandra. The data is replicated to multiple successor nodes. This assures the data availability in case of node failures.

Push Based Distributed Mapping Approach

The push based distributed mapping approach includes a highly distributed dissemination approach where each of the nodes disseminates indexes of its local cached items as well as other nodes cached items (known from previous dissemination iterations) to a subset of other nodes using deterministic or random-based methods. In that way, every node will have local mapping repository tables to be used during cache item discovery process. Upon local cache miss, a reference to other nodes repository tables (locally placed on node) will take place.

One of the efficient methods to disseminate the indexes of local cached items is to use bloom filters. Bloom filters are a compact method of representing a set of items. It is a space-efficient probabilistic data structure that is used to test whether an element is a member of a set. False positives are possible, but false negatives are not; i.e. a query returns either “inside set (may be wrong)” or “definitely not in set”. Elements can be added to the set, but not removed (though this can be addressed with a counting filter). The more elements that are added to the set, the larger the probability of false positives.

An empty Bloom filter is a bit array of m bits, all set to 0. There must also be k different hash functions defined, each of which maps or hashes some set element to one of the m array positions with a uniform random distribution. To add an element, feed it to each of the k hash functions to get k array positions. Set the bits at all these positions to 1.

To query for an element (test whether it is in the set), it is possible to feed it to each of the k hash functions to get k array positions. If any of the bits at these positions are 0, the element is definitely not in the set—if it were, then all the bits would have been set to 1 when it was inserted. If all are 1, then either the element is in the set, or the bits have by chance been set to 1 during the insertion of other elements, resulting in a false positive. In a simple bloom filter, there is no way to distinguish between the two cases, but more advanced techniques can address this problem.

Removing an element from this simple Bloom filter is impossible since false negatives, which are not permitted, may be encountered. An element maps to k bits, and although setting any one of those k bits to zero suffices to remove the element, it also results in removing any other elements that happen to map onto that bit. Since there is no way of determining whether any other elements have been added that affect the bits for an element to be removed, clearing any of the bits would introduce the possibility for false negatives. In order to overcome this problem, a counter can be used instead of a single bit representing the number of items in which this bit is set. In that case, removing an item simply decrements the counter, so practically the bit is still being set.

Each of the content mapping approaches has its limitations, especially when applied to medium scale managed data delivery networks such as mobile operator network.

The pull based approach, although introducing fast mapping knowledge dissemination due to its centralized operation mapping operation, has some drawbacks:
Hotspot like load—For a very popular content, a mapping node will become peak loaded. If mapping nodes resources are limited (as is usually the case in highly distributed caching system), latency due to packet loss or queuing delays will be encountered.
Distant mapping node—the allocation of unique IDs to mapping nodes (within hashing process) does not ensure locality of mapping node and introduced added mapping latency.

The push based approach, although introducing efficient mapping knowledge dissemination due to its direct mapping operation, also has some drawbacks:
Relatively long network coverage time—the time needed for a bloom filter updated in one node to be disseminated over an entire network depends on network topology (on average it will be logarithmic). For frequent real time content mapping access, this may be too slow and can lead to inefficient content delivery paths.
High control overhead—For frequent popular content access updates within nodes, the overhead of bloom filters dissemination between nodes will become a significant factor.

Following the limitations of each of the mapping approaches, none of them, as a single solution, can be fully optimized to the dynamic nature of content consumption and its impact of discovery process within the content delivery networks.

It is therefore clear that for the pull-based dissemination approach, a method is needed for eliminating or refining the hot spot load, as well as for localizing the mapping node server.

Similarly, for the push-based dissemination approach, methods for control overhead reduction and reduced coverage time are needed.

Finally, having in mind the fundamental embedded architecture limitations for each of the approaches, a dynamic combination of the push-pull-based approaches need to be provided, which is highly optimized to the content type, its popularity and its access rate within network.

### SUMMARY OF THE INVENTION

The invention relates to a method for the dynamic content discovery in a distributed caching network, wherein the distribution of content popularity and its access frequency rate are used to determine the most appropriate mapping method(s) to use. In one embodiment of the invention the mapping method is selected from pull-based and push-based mapping, or a combination thereof. In another embodiment of the invention the content popularity is determined by counting the number of times the content is accessed by different requesters.

The access frequency rate can be weighed in different ways, but according to one embodiment of the invention it is simply the access rate of a given content from different requesters in a given time interval.

The dynamic mapping system may comprise in one embodiment of the invention two or more subsystems selected from among Content monitoring and tracing subsystem, Content mapping decision subsystem and Content mapping dissemination subsystem.

In one specific embodiment of the invention, the method of the invention comprises the following steps:
a) Upon new content access, the content monitoring subsystem updates the contents statistics;
b) If continuous statistics reporting is supported or reporting time interval reached, statistics are forwarded to the content mapping selection subsystem; otherwise, the process is terminated;
c) Upon reception of the content statistics, the content mapping selection subsystem decides of the most appropriate mapping approach to be used;
d) If the selected mapping approach is different than the current mapping approach, a new mapping approach is forwarded to the content mapping dissemination subsystem; otherwise, the process is terminated; and
e) The content mapping dissemination subsystem updates the dissemination mapping approach to be used.

In a method according to one embodiment of the invention a pull-based method is used, which employs an efficient Sub-DHT-based algorithm is used, given a peers size group of less than 10K and low churn rate. Moreover, a chord-based consistent hash algorithm with full membership can be used and consistent hashing can be employed to map between content sections and peers that are responsible for them.

In an embodiment of the invention in which a push-based method is used, bloom filters can be used as a cache digest of keys that are stored in a local cache and furthermore, the network overhead within a network during the dissemination of the bloom filters can be reduced, if desired, by having each node advertise only the differences between the previously advertised filters and the new filters. When operating according to this procedure it may be desirable that, at given time intervals, every node advertise its complete bloom filters bit arrays.

Thus, according to one particular embodiment of the invention:
i. If content is locally cached (local bloom filter hit), the process ends;
ii. If content is not cached locally (local bloom filter miss), the content is locally checked on other nodes bloom filters; otherwise (network bloom filter hit), content is retrieved from the best (for instance closest) caching node;
iii. Content is updated on local bloom filter; and
iv. If a full bloom filter update is required, disseminate the full local bloom filter to relevant peer nodes; otherwise disseminate only bloom filter differences to relevant peer nodes.

The invention also encompasses a system for the dynamic content discovery in a distributed caching network, comprising circuitry suitable to determine the most appropriate mapping method to use based on the distribution of content popularity and its access frequency rate.

### BRIEF DESCRIPTION OF THE DRAWINGS

In the drawings:

FIG. 1 is a diagram describing the content mapping operational diagram of a pull based approach;

FIG. 2 is a diagram describing the content mapping operational diagram of the push-based approach; and

FIG. 3 describes the operational sequence of the dynamic mapping selection system.

### DETAILED DESCRIPTION OF THE INVENTION

The invention provides improvements for each of the known mapping dissemination approaches and further provides a dynamic mapping dissemination method selection based on provisioning and monitoring of the current content consumption characteristics within the network, such as content type, access rate, popularity, etc.

The invention addresses both the push- and pull-based mapping approaches, and provides a dynamic mapping mode selection solution.

Pull Based Mapping Approach

According to the invention an efficient Sub-DHT-based algorithm is used, given a relatively small peers size group (less than 10K) and low churn. The algorithm uses chord-based consistent hash algorithms with full membership (implying a single hop store and lookup).

Consistent hashing is used to map between content sections and peers that are responsible for them. That is, each peer is assigned a hashed ID over a cyclic range (e.g., MD5), and each stream section is also assigned such an ID. The peer that is responsible for mapping a given section is the one whose hashed ID is the smallest one that is larger or equal to the sections hashed ID. As full membership knowledge is assumed, contacting the responsible peer is done within one overlay routing hop. If the number of peers is less than 1,000, virtual peers are employed (one physical node is responsible for several keys within key range).

In order to reduce the load on responsible peers for popular sections, and to provide fault-tolerance, instead of having a single responsible node for each section, there will be r such peers. They will be defined as hash(i_<section-url>), where i is an integer between 1 and r. When a peer needs to access the DHT, it will access the nearest of these r responsible peers. If such a peer times out, then the 2^{nd} best node will be contacted etc. Accordingly, using multiple hash functions will increase the probability for close proximity lookup. The closeness of a mapping node is determined using a calculated cost function value composed of some combination of several parameters such as: nodes load, memory usage, CPU usage, hop distance, latency, etc.

For content composed of multiple sequential sections, such as HTTP Live Streaming (HLS), in order to reduce the number of accesses to the DHT an access to the DHT can be for multiple sections. The sections can either be continuous, or in groups of w sections for some parameter w (i.e., section j, j+w, j+2w, etc . . . ).

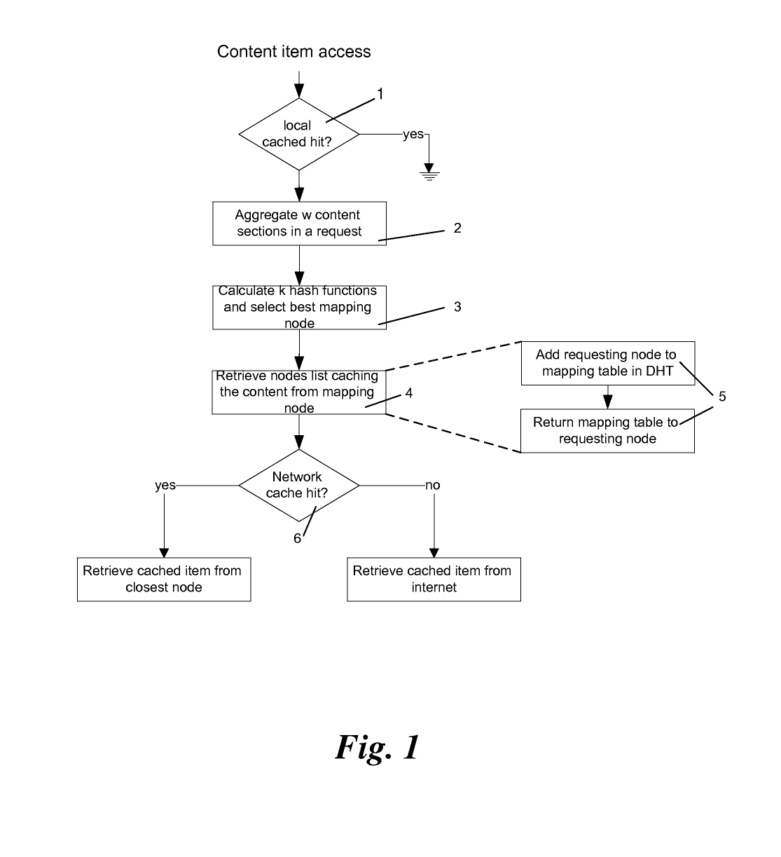

FIG. 1 describes the content mapping operational diagram of the pull based approach:
1. If the content is locally cached (local cache hit), end of process (step indicated by numeral 1).
2. If the content is not cached locally (local cache miss), aggregate with mapping requests in one message (hot spot like elimination improvement) (2).
3. Calculate k hash functions of mapping nodes, and select the best mapping node (latency reduction optimization) (3).
4. Content's mapping table is retrieved from DHT mapping node (4).
5. Upon mapping request, the DHT mapping node returns the mapping table of nodes caching the requested content and adds the requesting node to the content mapping table (as it becomes a new caching node) (5).
6. If content is cached in the network (network cache hit), content is retrieved from the best caching node. Otherwise (network cache miss), content is retrieved from the Internet (6).

Push Based Mapping Approach

According to the invention bloom filters are used as a cache digest of keys that are stored in a local cache. Lookup on bloom filters is a local query. Therefore, each peer is required to distribute its local bloom filter to other nodes in the network. Each peer will maintain a list of bloom filters representing the cache digests of the remote peers in the network. For every update a version number will be incremented. Versioning will ensure that only newer updates will be written.

To keep the Bloom filters at a reasonable size, only the m (e.g., 100) most popular sections will be stored in the Bloom filter of each peer. Also, for real time traffic each section has a relatively short time-to-live, i.e., the maximal delay, after which it is no longer relevant.

In order to reduce the network overhead within a network during the dissemination of the bloom filters, complete Bloom filters will be sent rarely. Instead, each node will advertise only the differences between the previously advertised filters and the new filters. The latter would typically be very sparse vectors, which can be compressed effectively. Still, for having consistency of nodes having lost part or all of the bloom updates, at given time intervals, every node can advertise its complete bloom filters bit arrays. Versioning can be added to help recovering from lost transmissions, duplications, etc.

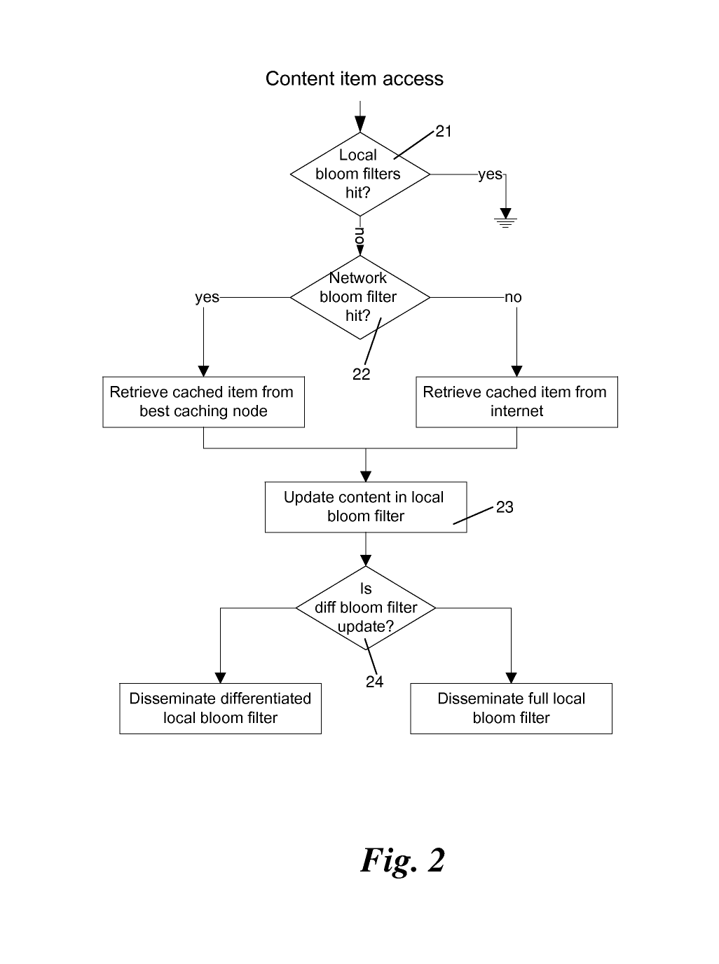

FIG. 2 describes the content mapping operational diagram of the push-based approach:
1. Content is locally cached (local bloom filter hit), end of process (step indicated by numeral 21).
2. If the content is not cached locally (local bloom filter miss), content is locally checked on other nodes bloom filters. Otherwise (network bloom filter hit), content is retrieved from the best caching node (22).
3. Content is updated on local bloom filter (23).
4. If full bloom filter update is required, disseminate the full local bloom filter to relevant peer nodes. Otherwise, disseminate only bloom filter differences to relevant peer nodes (24).

Dynamic Mapping Approach

An alternative embodiment of the invention takes into account the adequacy of each of the approaches to different content's popularity and access rates, and provides an efficient solution based on either approach or their combination. More specifically, the distribution of content popularity and its access frequency rate are used to determine the most appropriate mapping method to use:
Popularity/Rank—How popular the content is within the network. Popularity can be simply traced by counting the number of times the content is accessed by different requesters.
Access rate—The access rate of a content from different requesters in a given time interval.

Accordingly, the invention provides a dynamic mapping system selection decision (pull based and/or push based) according to content's consuming properties. The dynamic system's target is to allow an adaptive operational mode with lowered control overhead as possible over the network, still with high efficiency (i.e. shortest discovery cycle) and optimized highly localized data delivery to end users (i.e. delivery offload from core network). According to an embodiment of the invention the dynamic mapping system is composed of the following subsystems:

Content monitoring and tracing subsystem—this subsystem is responsible for gathering statistics of content's consumption properties its popularity and its access rate. The statistics can be gathered in a centralized (i.e. by a DHT mapping node) or distributed (i.e. by every participating caching entity in the system) manner. The gathered statistics is forwarded to the content mapping decision subsystem. Statistics forwarding can be done continuously per content access or per time interval.

Content mapping decision subsystem—based on the continuous information gathered by the content monitoring and tracing subsystem, this subsystem is responsible for the decision of the most appropriate mapping mechanism to be used based on lowered control overhead and most efficient data delivery path. Such a decision can be made using a set of one or more threshold values related to the decision criteria (as content popularity and access rate). When thresholds values are reached, a triggering for the mapping system update is initiated within the subsystem and the next mapping system is selected. When a new mapping system is used, a notification will be sent to the content mapping dissemination subsystem. The mapping system selection can be done per specific content or globally for the whole system contents. The subsystem can be implemented in a centralized manner and/or in a distributed manner. In the centralized approach, one replicated server is used for the decision algorithm, while in the distributed approach a consensus algorithm can be used between participating caching entities.

Content mapping dissemination subsystem—following the mapping decision of the content mapping selection, this subsystem is responsible for executing the selected mapping mechanism.

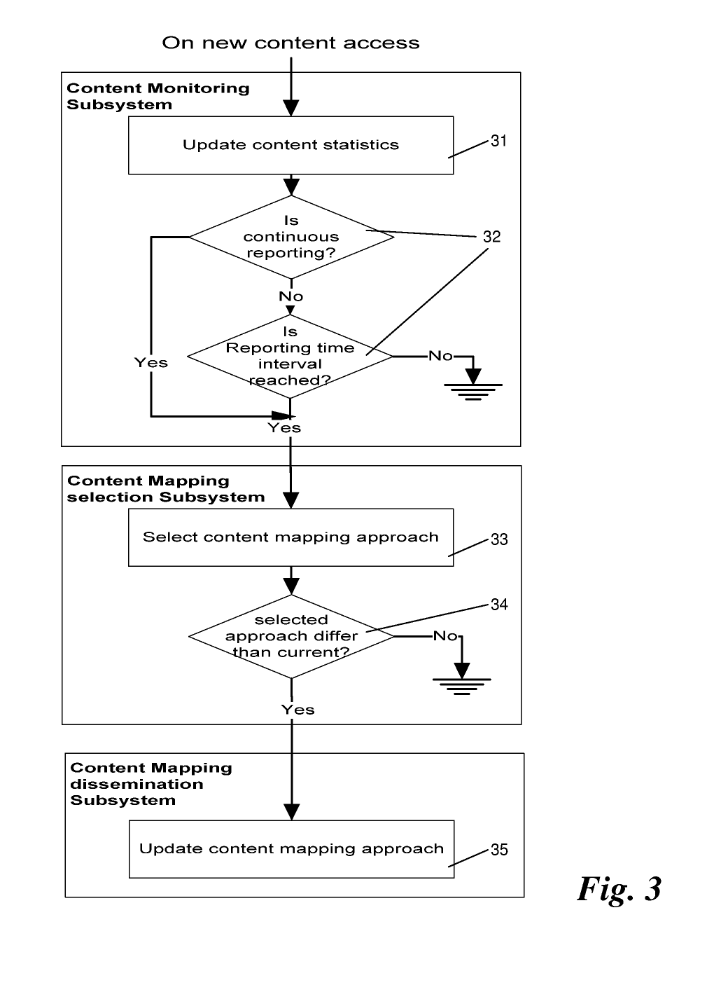

FIG. 3 describes the operational sequence of the dynamic mapping selection system:
1. Upon new content access, the content monitoring subsystem updates the contents statistics, such as number of access times, access time, etc. (step indicated by numeral 31).
2. If continuous statistics reporting is supported or reporting time interval reached, statistics are forwarded to the content mapping selection subsystem. Otherwise, the process is terminated (32).
3. Upon receipt of the content statistics, the content mapping selection subsystem decides on the most appropriate mapping approach to be used (33).
4. If the selected mapping approach is different from the current mapping approach, a new mapping approach is forwarded to the content mapping dissemination subsystem. Otherwise, the process is terminated (34).
5. The content mapping dissemination subsystem updates the dissemination mapping approach to be used (35).

As an example for a mapping system decision making, let's assume that push based dissemination is set as the default mapping system for a content. An access rate threshold is set within the content mapping decision subsystem. Using the content monitoring and statistics accepted from the network nodes, the content access rate is continuously checked against the threshold value. Assuming that the content is a live video with a low popularity, the push-based approach is found to be appropriate (the access rate threshold is not reached). Let's now assume that at a certain time (for example a popular program scheduled for a specific hour) the content becomes a very popular live video with high access rate (as viral spread). As a result, the access rate threshold value is reached and the mapping decision subsystem decides that a pull-based mapping approach is more appropriate to serve the content type. Accordingly it sends an indication to the dissemination subsystem, which in turn replaces the push approach with the pull approach.

The same approach can be used if a global content mapping decision is used for the entire system contents consumed. In that case, the set of threshold values will be related to the averaging statistics of the entire consumed content in the system.

When a combination of pull- and pushed-based approach is used, for example using the pull based approach as the base approach, with a push-based approach as a complementary mapping, the mapping decision subsystem will decide based on the same approach as above, if to add the push based approach to the pull based approach or not.

The dynamic content mapping solution allows an efficient content delivery network in several aspects:
It ensures efficient and fast-cached content location discovery within the network operator, with improved user experienced reflected in lower latency, because it is based on up-to-date content properties and statistics, such as access rate, number of accesses, QoS type, etc . . .
The dynamic selection of the mapping approach according to system operational mode ensures lower control plane overhead within the network operators during the content mapping process.
The efficient mapping process allows the selection of the best caching node available, which promises most efficient content fetching within operator network.

All the above description and examples have been provided for the purpose of illustration and are not intended to limit the invention in any way. As will be appreciated by the skilled person, the invention provides a highly competitive system as compared with content delivery network solutions known in the art.

1. A method for the dynamic content discovery in a distributed caching network, wherein the distribution of content popularity and its access frequency rate are used to determine the most appropriate mapping method(s) to use.

2. A method according to claim 1, wherein the mapping method is selected from pull-based and push-based mapping, or a combination thereof.

3. A method according to claim 1, wherein the content popularity is determined by counting the number of times the content is accessed by different requesters.

4. A method according to claim 1, wherein the access frequency rate is the access rate of a given content from different requesters in a given time interval.

5. A method according to claim 1, wherein the dynamic mapping system comprises two or more subsystems selected from among Content monitoring and tracing subsystem, Content mapping decision subsystem and Content mapping dissemination subsystem.

6. A method according to claim 5, wherein:
a) Upon new content access, the content monitoring subsystem updates the contents statistics;
b) If continuous statistics reporting is supported or reporting time interval reached, statistics are forwarded to the content mapping selection subsystem; otherwise, the process is terminated;
c) Upon reception of the content statistics, the content mapping selection subsystem decides of the most appropriate mapping approach to be used;
d) If the selected mapping approach is different than the current mapping approach, a new mapping approach is forwarded to the content mapping dissemination subsystem; otherwise, the process is terminated; and
e) The content mapping dissemination subsystem updates the dissemination mapping approach to be used.

7. A method according to claim 2, wherein a pull-based method is used, which employs an efficient Sub-DHT-based algorithm is used, given a peers size group of less than 10K and low churn rate.

8. A method according to claim 7, wherein a chord-based consistent hash algorithm with full membership is used.

9. A method according to claim 7, wherein consistent hashing is used to map between content sections and peers that are responsible for them.

10. A method according to claim 2, in which a push-based method is used, wherein bloom filters are used as a cache digest of keys that are stored in a local cache.

11. A method according to claim 10, wherein the network overhead within a network during the dissemination of the bloom filters is reduced by having each node advertise only the differences between the previously advertised filters and the new filters.

12. A method according to claim 11, wherein at given time intervals, every node advertises its complete bloom filters bit arrays.

13. A method according to claim 11, wherein
i. If content is locally cached (local bloom filter hit), the process ends;
ii. If content is not cached locally (local bloom filter miss), the content is locally checked on other nodes bloom filters; otherwise (network bloom filter hit), content is retrieved from the best caching node;
iii. Content is updated on local bloom filter; and
iv. If a full bloom filter update is required, disseminate the full local bloom filter to relevant peer nodes; otherwise disseminate only bloom filter differences to relevant peer nodes.

14. A system for the dynamic content discovery in a distributed caching network, comprising circuitry suitable to determine the most appropriate mapping method to use based on the distribution of content popularity and its access frequency rate.

15. A system according to claim 14, wherein the mapping method is selected from pull-based and push-based mapping or a combination thereof.
